(19) United States
(12) Patent Application Publication
(10) Pub. No.: US 2008/0135655 A1
(43) Pub. Date: Jun. 12, 2008

(54) Shutoff mechanism for shredder

(76) Inventors: Tie Chun Wang, Taipei (TW); William Huang, Taipei (TW)

Correspondence Address: SEDGWICK, DETERT, MORAN & ARNOLD, LLP (LA), 801 SOUTH FIGUEROA ST., 18TH FLOOR, LOS ANGELES, CA, 90017, US

(21) Appl. No.: 11/586,070

(22) Filed: Oct. 25, 2006

(51) Int. Cl. B02C 23/00; B02B 7/02; B02C 19/00

(52) U.S. Cl. 241/100

(57) ABSTRACT

The present invention relates generally to shutoff mechanisms for shredders. If an object of sufficient size or weight is inserted into a shredder, a panel on the shredder will move thus triggering a motion detection system. The motion detection system uses induction to gauge movement of the panel. When movement of the panel occurs through insertion of inappropriate objects, the power to the shredder is automatically turned off.

### BACKGROUND OF THE INVENTION

1. Field of the Invention

The present invention relates generally to shut-off mechanisms for shredders. Specifically, this invention teaches various shut-off mechanisms for automatically turning off the power to a shredder.

2. Background Information

With increased privacy concerns, shredders have become an integral part in both homes and businesses. Though originally used to destroy paper products, shredders now are used for other forms of media that hold information, such as compact discs. In addition, credit cards and other plastic products are commonly shredded.

The United States Consumer Product Safety Commission (“CPSC”) published a document entitled Paper Shredder Safety Alert (Document #5127, May 2004). According to this report in the 3 year period from January 2000 through December 2003, the CSPC received 31 reports involving finger amputations, lacerations, and other finger injuries from paper shredders.

In addition, one of the major factors in contributing to paper shredder malfunctions is overloading the shredder. When the number of sheets that are placed in a shredder exceed the maximum, the likelihood of the paper shredder breaking down increases dramatically.

In order to reduce both the likelihood of injuries and shredder malfunctions, the present invention seeks to employ various motion detection mechanisms that automatically shutoff the shredder.

The claimed invention provides this protection by maintaining power only when the shredder is being properly used. In other situations, when an object of sufficient size or weight is inserted in the shredder, it triggers a motion detector which automatically shuts off the shredder. From the preceding descriptions, it is apparent that the devices currently being used have significant disadvantages and/or limitations. Thus, important aspects of the technology used in the field of invention remain amenable to useful refinement.

### SUMMARY OF THE INVENTION

The present invention relates to an apparatus that satisfies the need for an automatic shutoff mechanism for paper shredders. In one preferred embodiment, a safety mechanism on a shredder having features of the present invention comprises a panel on a shredder which uses inductive properties to detect when objects of a sufficient size or weight are inserted into the shredder. If, for example, too many pieces of paper are placed in the shredder, or if a foreign object is placed in the shredder, the shredder panel will move, thus triggering a series of events that turn off the shredder.

All of the foregoing operational principles and advantages of the present invention will be more fully appreciated upon consideration of the following detailed description with reference to the drawings.

### BRIEF DESCRIPTION OF THE DRAWINGS

The features and advantages of this invention are better understood with regard to the following drawings, description, and claims. The drawings consist of the following:

FIG. 1 is a perspective view of an apparatus embodying features of this invention.

FIG. 2 is a cross-sectional view of the side of a housing and panel embodying features of this invention.

FIG. 3 is a cross-sectional view of the side of a housing and panel embodying features of this invention.

FIG. 4 is an exploded view of the panel and appendages of this invention.

FIG. 5 is a cross-sectional view of the side of an apparatus embodying features of this invention illustrating the depression into which the appendages fit.

FIG. 6 is a cross-sectional view of an apparatus embodying features of this invention.

FIG. 7 is a cross-sectional view of the side of a housing and panel embodying features of this invention.

FIG. 8 is a cross-sectional view of the side of a housing and panel embodying features of this invention.

FIG. 9 is an exploded cross-sectional view of the side of a panel embodying features of this invention.

FIG. 10 is a bottom perspective view of a housing embodying features of this invention.

FIG. 10(a) is an exploded bottom perspective view of a housing embodying features of this invention.

FIG. 11 is a cross-sectional view of the side of a housing embodying features of this invention.

FIG. 12 is a diagram of the general elements of a system embodying features of this invention.

FIG. 13 is a schematic diagram of the frequency generator for an apparatus embodying features of this invention.

FIG. 14 is a diagram of the elements of the microprocessor for an apparatus embodying features of this invention.

### DETAILED DESCRIPTION OF THE INVENTION

This invention discloses a paper or media shredder with an automatic shut-off mechanism. The shredder automatically shuts off when an object greater than the shredder opening or of sufficient weight is inserted into the shredder. The object will cause the panel of the shredder to move, triggering a motion detecting mechanism which shuts off the shredder.

The essential elements of a shredder are comprised of a base 1, a housing 2, and a shredder mechanism (not shown). The base 1 and shredder mechanism can be of any sort commonly known to those skilled in the art and are thus not described herein.

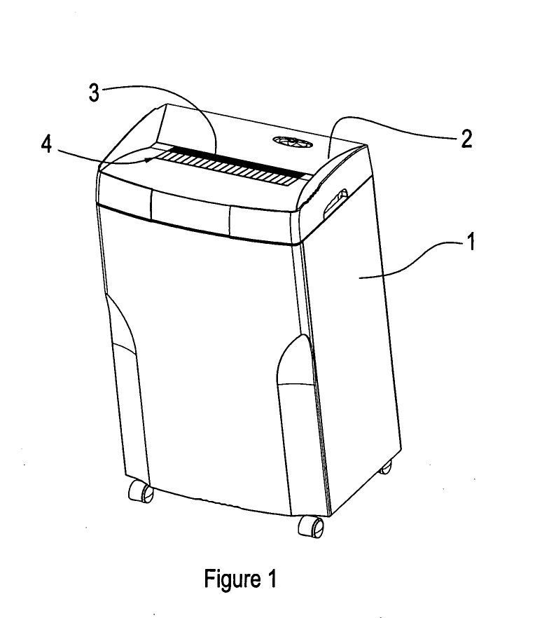

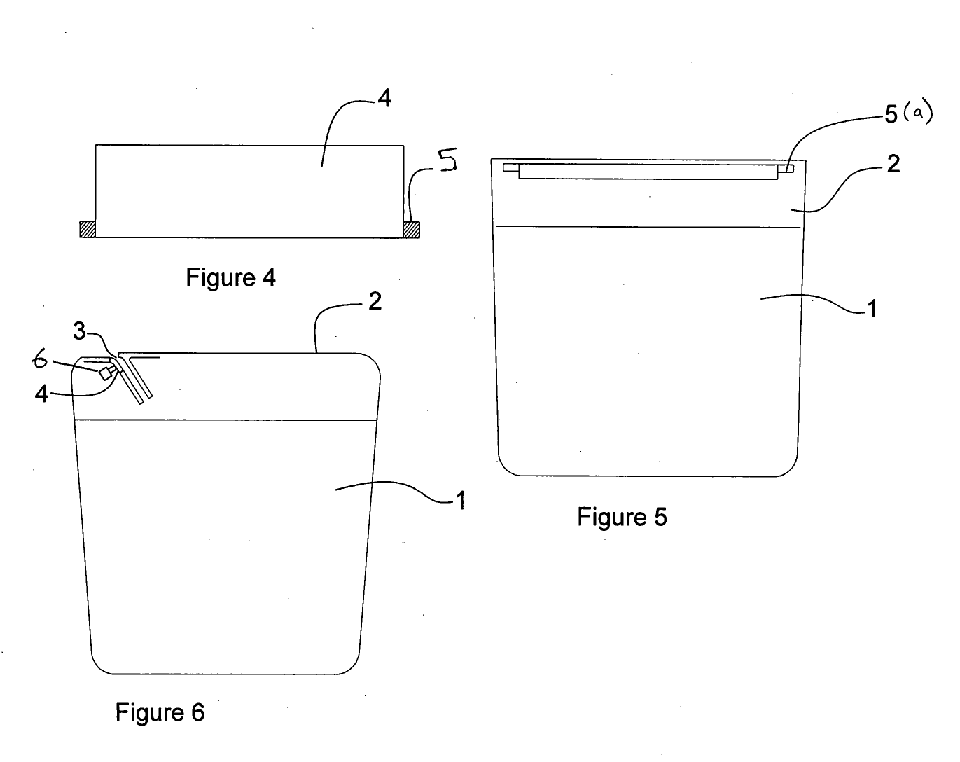

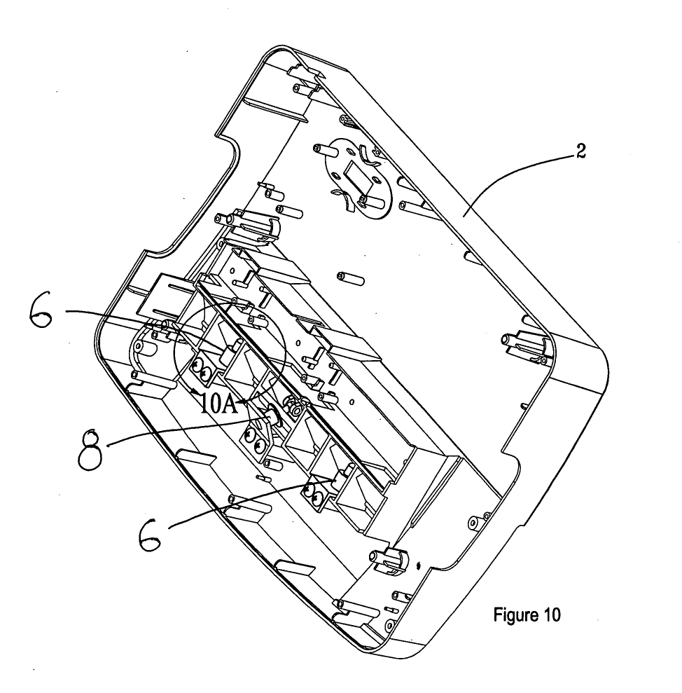

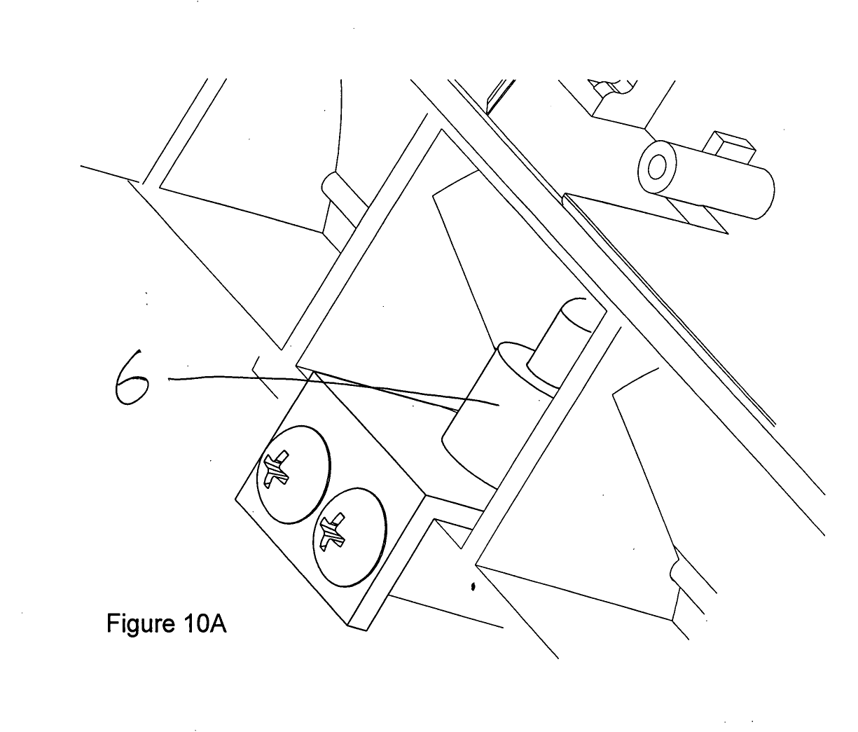

FIGS. 1-11 disclose a preferred embodiment of a shredder with a shut-off mechanism. The housing 2 has a shredder mechanism inside of it and rests on top of the base 1. The housing 2 has a throat 3 through which material to be shredded is inserted. The material enters the throat 3 and is shredded by the shredder mechanism in the housing 2. The shape of the throat 3 is determined by the housing 2 and a panel 4 coupled to the housing 2. As seen in FIG. 4, the panel 4 has an appendage 5 protruding from opposite sides of the panel 4. Each appendage 5 fits inside a depression 5(a) (See FIG. 5) in the housing 2 of the paper shredder. The panel 4 is capable of moving around the axis 5(b) formed by the coupling of the appendages 5 and the depressions 5(a).

It should be appreciated that the axis around which the panel pivots can also be formed if the panel contains a depression on opposite sides of the panel instead of an appendage. In this embodiment, the housing would contain the appendages which would fit into the panel depressions. The panel is thus capable of pivoting around the axis formed by this coupling.

The panel 4 is pre-disposed to be in a position to allow material to be shredded. If an object is inserted into the throat 3 of sufficient size and force to move the panel 4, the panel movement will trigger a motion detecting system which will automatically shut off the shredder as described below.

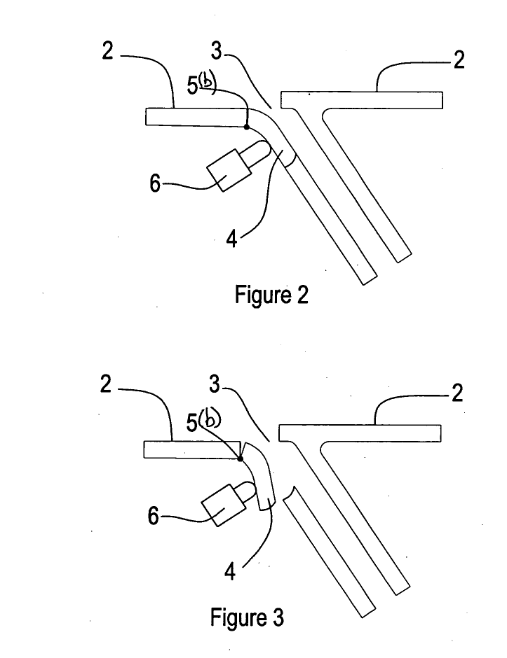

As seen in FIGS. 2, 3, 6, 10 and 10(a) one preferred method for preventing inadvertent triggering of the automatic shut-off mechanism is to have a spring mechanism 6 press up against the panel 4. As seen in FIG. 2, the spring mechanism 6 maintains the panel 4 in the predisposed operating position and secures the panel 4 to the housing 2 preventing inadvertent movement of the panel 4 during regular shredding activities. When an object of sufficient size and/or weight is placed through the throat 3, the panel 4 will move in spite of the force of the spring mechanism 6. This movement will trigger the motion detecting mechanism described below, which is capable of detecting panel movement, whereby the motion detecting mechanism turns the power off to the shredder upon said movement.

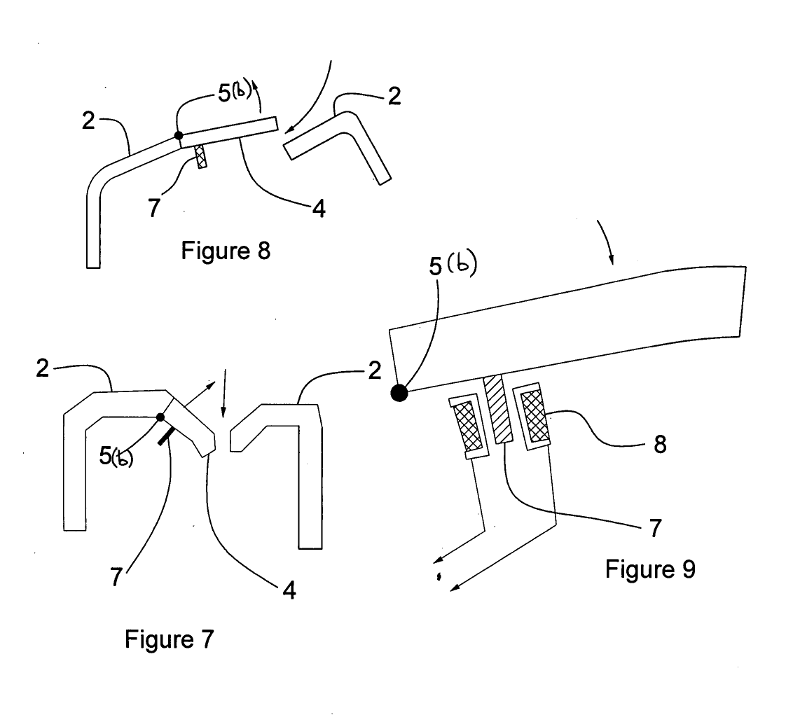

FIGS. 7 and 8 illustrate different configurations of the panel 4 and housing 2. The direction of panel movement can vary depending on the configuration. In FIG. 7 if an object places sufficient force on the panel 4, the panel 4 will move downward. Conversely, in FIG. 8, an object placing sufficient force on the panel 4 will cause it to move upward. Only when an object exerts a force sufficient to move the panel 4 will the motion detecting system trigger the automatic shut-off mechanism.

Motion Detecting Mechanism:

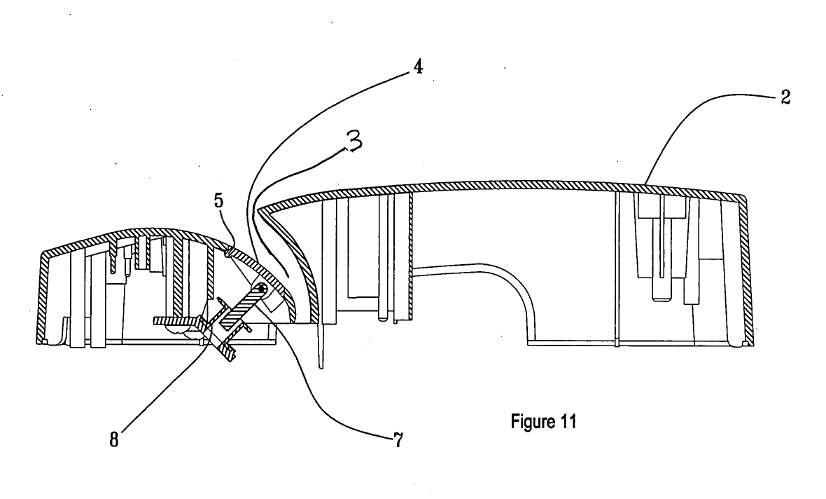

One preferred embodiment for the motion detecting mechanism uses induction to detect panel movement and trigger the automatic shutoff of the shredder. In this embodiment a magnetic rod such as an iron rod 7 is attached to the panel 4. In the normal position, the iron rod 7 fits through a copper coil 8 which is connected to a frequency generator. See FIGS. 9 and 11.

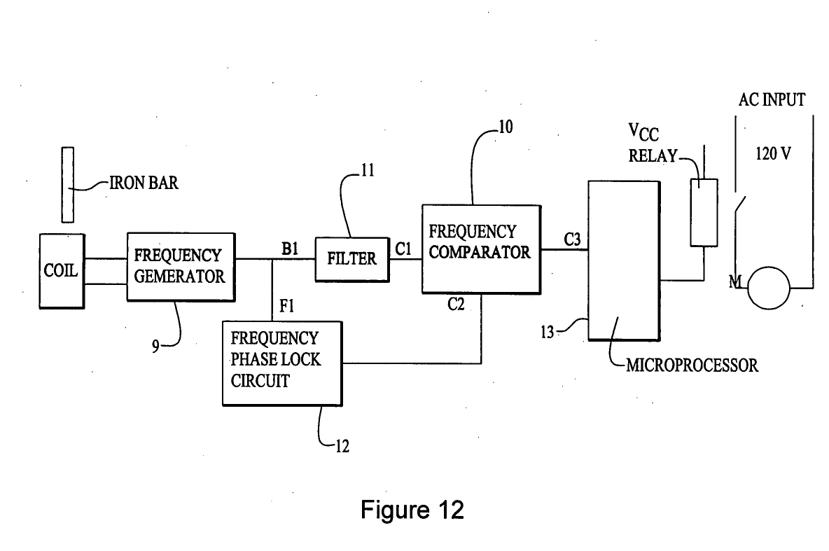

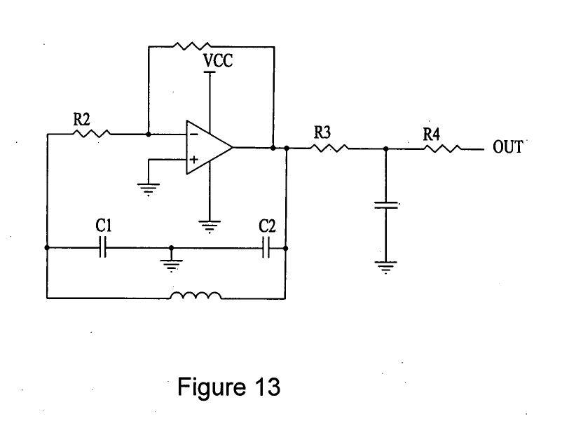

FIGS. 12-14 are schematics illustrating the induction mechanism and its components. The coil 8 generates a magnetic field which interacts with the frequency generator 9 in emitting a constant signal such as a repetitive waveform. The frequency generator can be of any suitable configuration commonly known to those skilled in the art. (For example, see FIG. 13 for a schematic diagram of a frequency generator for an apparatus embodying features of this invention.)

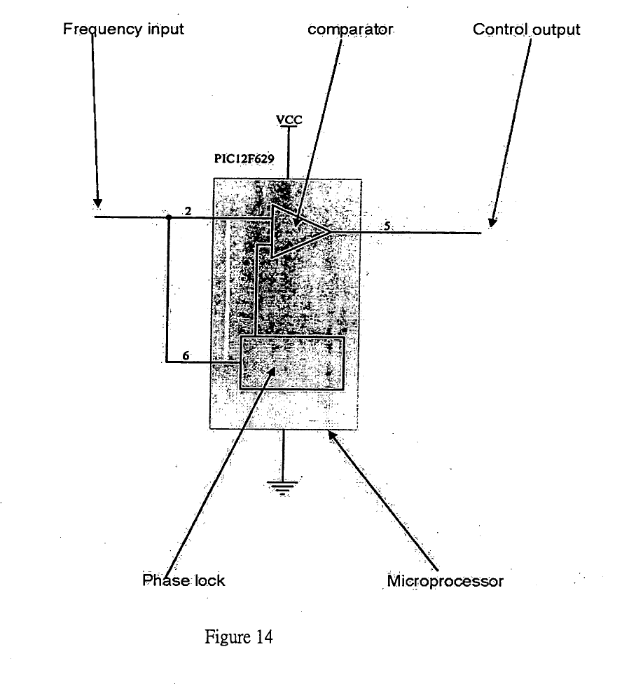

The signal generated by the frequency generator 9 then takes two paths to a frequency comparator 10. One path goes directly through a filter 11 which reduces other interfering signals. The other path travels through a frequency phase lock circuit 12 and then to the frequency comparator 10. FIG. 14 is a diagram of the elements of a microprocessor with the comparator 10 and the phase lock circuit 12. It is preferably one such as Microcihp's PIC12f629, but can be any microprocessor with similar functionality as is commonly known in the art.

When the panel 4 is in the predisposed position, and there is no movement, the two signals entering the frequency comparator 10 are the same and constant. The frequency comparator 10 then exports a low-voltage to another microprocessor 13 which is capable of turning off the power to the shredder depending on the incoming voltage. At a low voltage the microprocessor 13 is configured such that the shredder is not turned off. This type of microprocessor 13 is commonly known in the art and thus not described herein. Additionally, instead of a microprocessor, any commonly known circuit or relay switch capable of turning off the shredder may be used.

When the panel 4 moves and the iron bar 7 changes position, the inductance changes. The electromotive force of the iron bar causes a momentary change in the current flowing into the frequency generator 9 causing the frequency generator's output signal to change. The different output signal goes through the filter 11 and into the frequency comparator 10, which will be different then the signal entering the frequency comparator 10 through the frequency phase lock circuit 12. The output of the frequency comparator 10 represents the phase difference between the two oscillating input signals. This difference in wave forms will cause the frequency comparator 10 to generate a voltage triggering the microprocessor 13 or comparable circuit or relay to shut down the power to the shredder.

Other preferred embodiments are also possible. For example, rather than automatically shutting off the shredder, the shredder can be programmed to momentarily operate in the reverse direction. This may be useful for dislodging foreign objects that were inadvertently inserted into the shredder. In addition, rather than use electromagnetic properties for motion detection, other possible means include infrared or optical technologies.

Although the present invention has been described in detail with respect to certain preferred versions thereof, other versions are possible. Therefore, the scope of the claims should not be limited to the description of the preferred versions contained herein.

1. A shredder housing comprised of:
(a) a throat through which materials to be shredded may be fed;
(b) a shredder mechanism for shredding materials fed through the throat;
(c) a panel coupled to the housing capable of movement; and
(d) a motion detecting mechanism capable of detecting panel movement, whereby said motion detecting mechanism turns the power off to said shredder mechanism upon panel movement.

2. The shredder of claim 1 wherein a spring mechanism maintains said panel in a predisposed position.

3. The shredder of claim 1 or 2 wherein said motion detecting mechanism uses induction to detect panel movement.

4. A shredder housing comprised of:
(a) a throat through which materials to be shredded may be fed;
(b) a shredder mechanism for shredding materials fed through the throat;
(c) a panel coupled to the housing capable of movement;
(c) a magnetic rod attached to said panel;
(d) a coil through which said magnetic rod fits; and
(e) a motion detecting mechanism capable of detecting panel movement, whereby said motion detecting mechanism turns the power off to said shredder mechanism upon panel movement.

5. The shredder of claim 5 wherein a spring mechanism maintains said panel in a predisposed position.

6. The shredder of claim 4 or 5 wherein said motion detecting mechanism uses induction to detect panel movement.
